(19) United States
(12) Patent Application Publication
(10) Pub. No.: US 2024/0059321 A1
(43) Pub. Date: Feb. 22, 2024

(54) TRAVEL CONTROLLER AND TRAVEL CONTROL METHOD

(71) Applicants: TOYOTA JIDOSHA KABUSHIKI KAISHA, Toyota-shi (JP); DENSO CORPORATION, Kariya-city (JP)

(72) Inventor: Ryusuke Kuroda, Edogawa-ku (JP)

(21) Appl. No.: 18/446,706

(22) Filed: Aug. 9, 2023

(30) Foreign Application Priority Data
Aug. 22, 2022 (JP) 2022-131960

(51) Int. Cl. B60W 60/00; B60W 50/08; B60W 50/14; B60W 30/182; B60W 40/09; B60W 40/04; G06V 20/59; G06V 20/58

(52) U.S. Cl. CPC B60W 60/0015; B60W 60/0059; B60W 60/0053; B60W 50/082; B60W 50/14; B60W 30/182; B60W 40/09; B60W 40/04; G06V 20/597; G06V 20/58; B60W 2420/42; B60W 2540/221; B60W 2554/408; B60W 2556/40

(57) ABSTRACT

A travel controller autonomously controlling travel of a vehicle, estimating an estimated arrival timing at which the vehicle is expected to arrive at a predetermined location where autonomous control can no longer be continued, starting notification of a transition demand demanding a transition of operation from the autonomous control to manual control a predetermined time period before the estimated arrival timing, ending the transition demand and the autonomous control and starting acceptance of a driving operation when a responsive motion of the driver to the transition demand is detected before the vehicle reaches the predetermined location, and ending the transition demand and the autonomous control and performing safe stopping control of acceleration, deceleration, and steering so that the vehicle stops at a safe position when the vehicle reaches the predetermined location without a responsive motion being detected.

### FIELD

The present disclosure relates to a travel controller and a travel control method for controlling travel of a vehicle.

### BACKGROUND

A travel controller which autonomously controls travel of a vehicle based on a surrounding image generated by a camera mounted on the vehicle can reduce the load on a driver caused by operation of the vehicle. However, the travel controller sometimes cannot control travel of the vehicle under a certain situation in which the vehicle is traveling.

Japanese Unexamined Patent Publication No. 2017-062539 (hereinafter, “PTL 1”) describes a travel controller which alerts a driver to a possibility of termination of autonomous driving when an alert condition such as the fall of a detection confidence score indicating certainty of vehicle surrounding information below a predetermined threshold value is determined satisfied. When a predetermined condition for termination of autonomous driving is determined to be satisfied in accordance with the detection confidence score at a location ahead on the road on which the vehicle is traveling, the travel controller described in PTL 1 estimates and alerts for the remaining time period until the autonomous driving is terminated. The travel controller described in PTL 1 maintains autonomous driving when the predetermined condition for termination of autonomous driving is not satisfied, and terminates autonomous driving when a predetermined condition for termination of autonomous driving is satisfied.

### SUMMARY

Safe operation of the vehicle may be difficult when a travel controller terminates autonomous control under a situation where the driver could not suitably drive the vehicle under manual control.

It is an object of the present disclosure to provide a travel controller that enables suitable control of operation of a vehicle after an end of travel under autonomous control.

A travel controller according to the present disclosure includes a processor configured to autonomously control at least one of acceleration, deceleration, and steering of a vehicle using map information. The processor of the travel controller further estimates an estimated arrival timing at which the vehicle is expected to arrive at a predetermined location where autonomous control can no longer be continued based on the current location of the vehicle and the map information. The processor of the travel controller further starts notification to a driver of a transition demand demanding a transition of operation from the autonomous control to a manual control of acceleration, deceleration, and steering of the vehicle by a driving operation of the driver of the vehicle a predetermined time period before the estimated arrival timing. The processor of the travel controller further ends the transition demand and the autonomous control and starts acceptance of the driving operation when a responsive motion of the driver to the transition demand is detected before the vehicle arrives at the predetermined location. The processor of the travel controller further ends the transition demand and the autonomous control and performs safe stopping control of acceleration, deceleration, and steering of the vehicle so that the vehicle stops at a safe position when the vehicle arrives at the predetermined location without a responsive motion being detected.

In the travel controller according to the present disclosure, the processor is preferably further configured to determine whether a state of the driver or a state of the surroundings of the vehicle is a state suitable for transition, and the processor in the safe stopping control ends the transition demand and the autonomous control and performs safe stopping control after the estimated arrival timing when the responsive motion has not been detected, the vehicle has not arrived at the predetermined location, and the state of the driver or the state of the surroundings of the vehicle is determined as not a state suitable for transition.

In the travel controller according to the present disclosure, the processor in determination of the state of the driver or the state of the surroundings preferably determines that the state of the driver is not a state suitable for transition when driving behavior of the driver for performing the driving operation is not detected from a driver image representing the driver generated by a driver monitor camera mounted on the vehicle.

In the travel controller according to the present disclosure, the processor in determination of the state of the driver or the state of the surroundings preferably determines that the state of the driver is not a state suitable for transition when biological information of the driver acquired by a biological information sensor mounted on the vehicle indicates an abnormality in a health condition of the driver.

In the travel controller according to the present disclosure, the processor in determination of the state of the driver or the state of the surroundings preferably determines that the state of the surroundings of the vehicle is not a state suitable for transition when an abnormal traffic flow is detected from a surrounding image representing the state of the surroundings of the vehicle acquired by a surrounding camera mounted on the vehicle.

A travel control method according to the present disclosure comprises autonomously controlling at least one of acceleration, deceleration, and steering of a vehicle by using map information, estimating an estimated arrival timing at which the vehicle is expected to arrive at a predetermined location where autonomous control can no longer be continued based on the current location of the vehicle and the map information, starting notification to a driver of a transition demand demanding a transition of operation from the autonomous control to a manual control of acceleration, deceleration, and steering of the vehicle based on a driving operation of the driver of the vehicle a predetermined time period before the estimated arrival timing, ending the transition demand and the autonomous control and starting acceptance of the driving operation when a responsive motion of the driver to the transition demand is detected before the vehicle reaches the predetermined location, and ending the transition demand and the autonomous control and performing safe stopping control of acceleration, deceleration, and steering of the vehicle so that the vehicle stops at a safe position when the vehicle arrives at the predetermined location without a responsive motion being detected.

A computer program for control stored in a non-transitory computer-readable medium according to the present disclosure causes a computer mounted on a vehicle to execute a process including autonomously controlling at least one of acceleration, deceleration, and steering of a vehicle by using map information, estimating an estimated arrival timing at which the vehicle is expected to arrive at a predetermined location where autonomous control can no longer be continued based on the current location of the vehicle and the map information, starting notification to a driver of a transition demand demanding a transition of operation from the autonomous control to a manual control of acceleration, deceleration, and steering of the vehicle based on a driving operation of the driver of the vehicle a predetermined time period before the estimated arrival timing, ending the transition demand and the autonomous control and starting acceptance of the driving operation when a responsive motion of the driver to the transition demand is detected before the vehicle arrives at the predetermined location, and ending the transition demand and the autonomous control and performing safe stopping control of acceleration, deceleration, and steering of the vehicle so that the vehicle stops at a safe position when the vehicle arrives at the predetermined location without a responsive motion being detected.

The travel controller according to the present disclosure suitably controls operation of a vehicle after the end of travel under autonomous control.

### BRIEF DESCRIPTION OF DRAWINGS

FIG. 1 schematically illustrates the configuration of a vehicle equipped with a travel controller.

FIG. 2 schematically illustrates the hardware of an ECU.

FIG. 3 is a functional block diagram of a processor included in the ECU.

FIG. 4 schematically illustrates determination of an estimated arrival timing.

FIG. 5 schematically illustrates an example of travel control.

FIG. 6 is a flowchart of a process for travel control.

### DESCRIPTION OF EMBODIMENTS

A travel controller that suitably controls operation of a vehicle after the end of travel under autonomous control will now be described in detail with reference to the attached drawings. The travel controller autonomously controls at least one of acceleration, deceleration, and steering of a vehicle by using map information. The travel controller estimates an estimated arrival timing at which the vehicle is expected to arrive at a predetermined location where autonomous control can no longer be continued, based on the current location of the vehicle and the map information. The travel controller starts notification to the driver of a transition demand demanding a transition of operation from the autonomous control to a manual control of acceleration, deceleration, and steering of the vehicle based on a driving operation of the driver of the vehicle a predetermined time period before the estimated arrival timing. The travel controller ends the transition demand and the autonomous control and starts acceptance of the driving operation when a responsive motion of the driver to the transition demand is detected before the vehicle arrives at the predetermined location. The travel controller ends the transition demand and the autonomous control and performs safe stopping control of acceleration, deceleration, and steering of the vehicle so that the vehicle stops at a safe position when the vehicle arrives at the predetermined location without a responsive motion being detected.

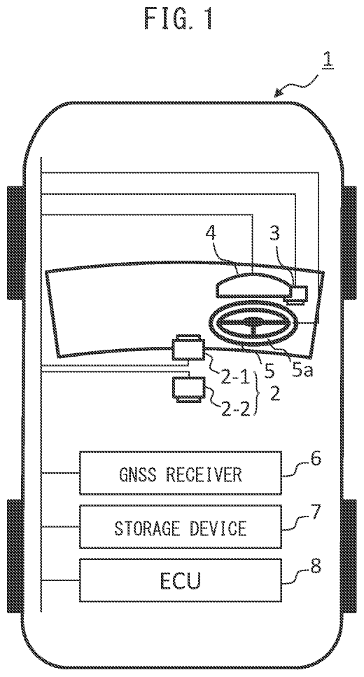

FIG. 1 schematically illustrates the configuration of a vehicle equipped with a travel controller.

The vehicle 1 includes surrounding cameras 2, a driver monitor camera 3, a meter display 4, a steering wheel 5, a global navigation satellite system (GNSS) receiver 6, a storage device 7, and an electronic control unit (ECU) 8. The ECU 8 is an example of the travel controller. The surrounding cameras 2, the meter display 4, the steering wheel 5, the GNSS receiver 6, and the storage device 7 and the ECU 8 are connected via an in-vehicle network conforming to a standard, such as a controller area network, so that they can communicate with each other.

The surrounding cameras 2 are examples of a surrounding imaging unit for generating surrounding images representing the situation around the vehicle 1. Each of the surrounding cameras 2 includes a two-dimensional detector constructed from an array of optoelectronic transducers, such as CCD or C-MOS, having sensitivity to visible light and a focusing optical system that forms an image of a target region on the two-dimensional detector. The surrounding cameras 2 include a front surrounding camera 2-1 and a back surrounding camera 2-2. The front surrounding camera 2-1 is disposed, for example, in a front and upper area in the interior of the vehicle and oriented forward, while the back surrounding camera 2-2 is disposed in a back and upper area in the interior of the vehicle and oriented backward. The surrounding cameras 2 respectively take pictures of the surroundings of the vehicle 1 through a windshield or a rear glass every predetermined capturing period (e.g., 1/30 to 1/10 seconds) and output surrounding images representing the situation in the surroundings.

The driver monitor camera 3 is an example of the driver imaging unit for generating a driver image representing the driver of the vehicle. The driver monitor camera 3 has a two-dimensional detector constructed from an array of optoelectronic transducers, such as CCD or C-MOS, having sensitivity to visible light and a focusing optical system that forms an image of a target region on the two-dimensional detector. The driver monitor camera 3 has a light source emitting infrared light. The driver monitor camera 3 is, for example, attached in the front in the interior of the vehicle oriented toward the face of the driver sitting in the driver's seat. The driver monitor camera 23 emits infrared light to the driver every predetermined capturing period (e.g., 1/30 to 1/10 seconds) and outputs driver images showing the driver in time series. The driver monitor camera 3 is also used as a biological information acquisition unit for acquiring biological information of the driver. The driver images generated by the driver monitor camera 3 are used as the biological information acquired by the biological information acquisition unit.

The meter display 4 is an example of an output device and includes, for example, a liquid crystal display. The meter display 4 shows a predetermined message to the driver according to a signal received from the ECU 8 via the in-vehicle network. The predetermined message includes, for example, a demand for a transition of operation from the autonomous driving mode in which at least one of acceleration, deceleration, and steering of the vehicle is autonomously controlled to a manual driving mode in which acceleration, deceleration, and steering of the vehicle are manually controlled. The vehicle 1 may also include, as an output device, a speaker device (not shown) outputting a voice representing the predetermined message, a light source (not shown) lighting up by a pattern corresponding to the predetermined message, a vibrator (not shown) vibrating by a pattern corresponding to the predetermined message, etc.

The steering wheel 5 is an example of an operation acceptance unit and is operated by the driver who makes a steering mechanism that steers the vehicle 1 operate. The operation to make the steering mechanism operate is, for example, turning the steering wheel 5 clockwise or counterclockwise. The steering wheel 5 includes a touch sensor 5a that detects hold of the steering wheel 5 by the driver. The touch sensor 5a outputs a signal depending on the presence or absence of hold of the steering wheel 5 by the driver.

The GNSS receiver 6 receives GNSS signals from GNSS satellites at predetermined intervals and determines the position of the vehicle 1 based on the received GNSS signals. The GNSS receiver 6 outputs a positioning signal indicating the result of determination of the position of the vehicle 1 based on the GNSS signals to the ECU 8 via the in-vehicle network at predetermined intervals.

The storage device 7, which is an example of a storage unit, includes, for example, a hard disk drive or a nonvolatile semiconductor memory. The storage device 7 contains map data including information on features, such as lane lines, in association with their positions.

The ECU 8 controls at least one of the acceleration, deceleration, and steering of the vehicle 1 by using the map information stored in the storage device 7 and the position of objects around the vehicle 1 represented in the surrounding images generated by the surrounding cameras 2. The ECU 8 estimates the estimated arrival timing at which the vehicle 1 is expected to arrive at a predetermined location where autonomous control can no longer be continued, based on the current position of the vehicle 1 and the map information. The ECU 8 starts notification to the driver of a transition demand a predetermined time period before the estimated arrival timing and controls the operation of the vehicle after the end of travel under autonomous control in accordance with the state at the end of travel under autonomous control.

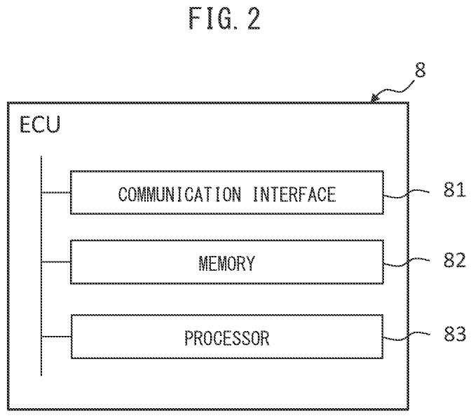

FIG. 2 schematically illustrates the hardware of the ECU 8. The ECU 8 includes a communication interface 81, a memory 82, and a processor 83.

The communication interface 81, which is an example of a communication unit, includes a communication interface circuit for connecting the ECU 8 to the in-vehicle network. The communication interface 81 provides received data to the processor 83. Further, the communication interface 81 outputs data provided from the processor 83 to an external device.

The memory 82 includes volatile and nonvolatile semiconductor memories. The memory 82 contains various types of data used for processing by the processor 83, e.g., conditions of terrain in the map information due to which autonomous control of travel would no longer be possible to continue, the predetermined time period for start of notification of a transition demand before the estimated arrival timing, a message to be notified as a transition demand, features of a responsive motion corresponding to the transition demand. The memory 82 also stores various application programs, such as a travel control program to execute therefor.

The processor 83, which is an example of a control unit, includes one or more processors and a peripheral circuit thereof. The processor 83 may further include another operating circuit, such as a logic-arithmetic unit, an arithmetic unit, or a graphics processing unit.

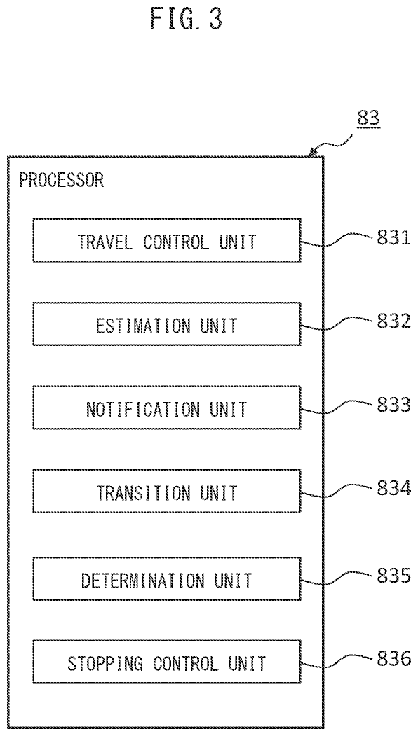

FIG. 3 is a functional block diagram of the processor 83 included in the ECU 8.

As its functional blocks, the processor 83 of the ECU 8 includes a travel control unit 831, an estimation unit 832, a notification unit 833, a transition unit 834, a determination unit 835, and a stopping control unit 836. These units included in the processor 83 are functional modules implemented by a program executed on the processor 83. Alternatively, the units included in the processor 83 may be implemented in the ECU 8 as separate integrated circuits, microprocessors, or firmware.

The travel control unit 831 autonomously controls at least one of the acceleration, deceleration, and steering of the vehicle by using the map information.

The travel control unit 831 acquires from the storage device 7 the map information representing the lane lines and other geographic features around the current position of the vehicle 1 identified by a positioning signal received from the GNSS receiver 6. The travel control unit 831 detects the lane lines in the surroundings of the vehicle 1 by inputting the surrounding images generated by the surrounding cameras 2 mounted on the vehicle 1 into a classifier that has been trained in advance to detect lane lines. The classifier may be, for example, a convolutional neural network (CNN) including a plurality of convolution layers connected in series from the input toward the output. A CNN that has been trained in accordance with a predetermined training technique, such as backpropagation using a plurality of images including lane lines as training data operates as a classifier to detect lane lines from a surrounding image.

The travel control unit 831 identifies the lane in which the vehicle 1 is currently traveling by comparing the lane lines detected from the surrounding images with the lane lines included in the map information. The travel control unit 831 outputs a control signal to a traveling mechanism (not shown) of the vehicle 1 so that the vehicle 1 travels along the lane currently traveling at a preset target speed. The traveling mechanism includes, for example, an engine or motor for accelerating the vehicle 1, a brake for decelerating the vehicle 1 decelerate, and a steering mechanism for steering the vehicle 1.

The travel control unit 831 may also detect another vehicle traveling in front of the vehicle 1 in the lane in which the vehicle 1 is traveling and output a control signal to the traveling mechanism of the vehicle 1 so as to keep the interval between the other vehicle and the vehicle 1 longer than a predetermined following distance threshold value. The travel control unit 831 detects the other vehicle positioned in the surroundings of the vehicle 1 by inputting surrounding images into a classifier that has been trained in advance to detect a vehicle or other object from the images. The classifier may be, for example, a CNN. A CNN that has been trained in accordance with a predetermined training technique, such as backpropagation using a plurality of images including vehicles and other objects as training data operates as a classifier to detect vehicles and other objects from a surrounding image. The travel control unit 831 may use the classifier trained in advance so as to detect vehicles as well as lane lines from images for detection of both other vehicles and lane lines from the surrounding images.

The travel control unit 831 identifies the lane in which the other vehicle is currently traveling by comparing lane lines in the surroundings of the other vehicle detected from the surrounding images with lane lines included in the map information. When the other vehicle is determined traveling in the lane in which the vehicle 1 is traveling, the travel control unit 831 estimates the interval between the other vehicle and the vehicle 1.

The travel control unit 831 may estimate the distance from the vehicle 1 to the object based on, for example, the ratio between the size of the region in which the object is represented in the surrounding image and a reference size on the surrounding images of the object at a reference distance, and the actual size of the object. The reference size on the surrounding images of an object at the reference distance and the actual size of the object may be stored in advance in the memory 82.

The estimation unit 832 estimates an estimated arrival timing at which the vehicle 1 is expected to arrive at a predetermined location where autonomous control can no longer be continued, based on the current position of the vehicle 1 and the map information stored in the storage device 7.

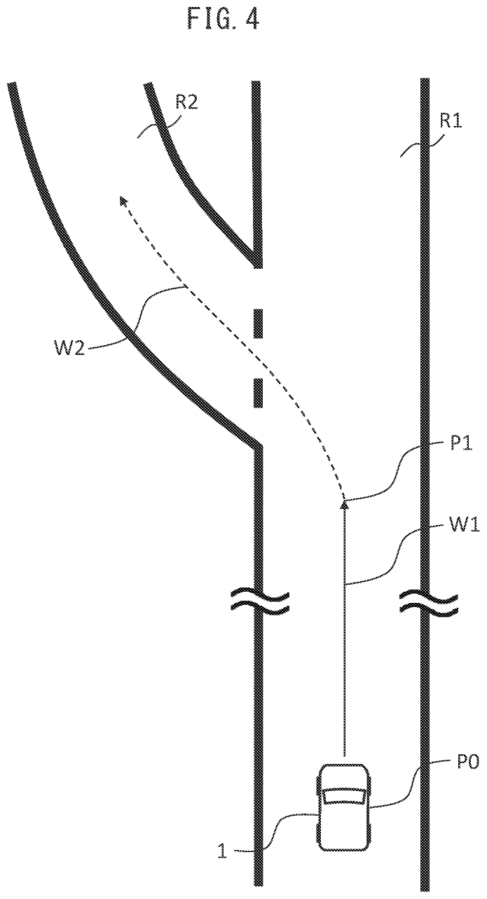

FIG. 4 schematically illustrates determination of an estimated arrival timing.

The vehicle 1 is traveling along a route W1 at a location P0 on a road R1 under autonomous control of the travel control unit 831. At a predetermined location P1 of the road R1, a road R2 branches off from the road R1. The road R2 is a road leading to a destination of the vehicle 1. The map information stored in the storage device 7 does not include information of the road R2. At such a predetermined location P1 corresponding to an end of the map information or a location where a lane change would be required, the travel control unit 831 can no longer continue autonomous control. The ECU 8 starts notification of a transition demand a predetermined time period before the estimated arrival timing at the predetermined location P1 so that the vehicle 1 travels on the road R2 along the route W2 by a transition from autonomous control to manual control.

The estimation unit 832 can estimate the time period required for arriving at the predetermined location P1 as the estimated arrival timing by dividing the distance from the location P0 to the predetermined location P1 by the speed of the vehicle 1. The speed of the vehicle 1 can be a speed measured by a speed sensor (not shown) mounted on the vehicle 1 or the average value of the speeds measured in the most recent predetermined length of time. The estimation unit 832 may also estimate the estimated arrival point of time obtained as a sum of the current point of time and the required time period needed for reaching the location P1 as the estimated arrival timing.

The notification unit 833 starts notification to the driver of a transition demand demanding a transition from autonomous control to manual control of the acceleration, deceleration, and steering based on a driving operation of the driver a predetermined time period before the estimated arrival timing.

The notification unit 833 determines whether the time period from the current point of time to the estimated arrival timing at the predetermined location P1 estimated by the estimation unit 832 is shorter than the predetermined time period stored in the memory 82. When the time period to the estimated arrival timing is shorter than the predetermined time period, the notification unit 833 starts to display on the meter display 4 a message of a transition demand represented by the text or image stored in the memory 82 (for example, “please hold the steering wheel”). The notification unit 833 may start playing back the message of the transition demand by a voice stored in the memory 82 from a speaker device (not shown) when the time period to the estimated arrival timing is shorter than the predetermined time period.

The transition unit 834 determines whether a responsive motion of the driver corresponding to the transition demand is detected before the vehicle 1 arrives at the predetermined location P1. When a responsive motion of the driver corresponding to the transition demand is detected before the vehicle 1 arrives at the predetermined location P1, the transition unit 834 ends the transition demand and the autonomous control and starts acceptance of a driving operation.

The responsive motion of the driver is, for example, a hold of the steering wheel 5 in response to the transition demand of “please hold the steering wheel”. The transition unit 834 determines that a responsive motion of the driver has been detected when the hold of the steering wheel 5 is detected based on a signal received from the touch sensor 5a of the steering wheel 5.

The transition unit 834 determines that the vehicle 1 has arrived at the predetermined location P1 when the distance between the current position of the vehicle 1 identified by the positioning signal received from the GNSS receiver 6 and the predetermined location P1 becomes smaller than a predetermined distance threshold value.

When a responsive motion is detected before the vehicle 1 arrives at the predetermined location P1, the transition unit 834 ends the transition demand by the notification unit 833 and the autonomous control of travel of the vehicle 1 by the travel control unit 831. In addition, the transition unit 834 accepts an operating signal corresponding to the operation of the driver to a driving operation acceptance unit such as the steering wheel 5, the accelerator pedal (not shown), and the brake pedal (not shown) and sends a control signal corresponding to the operating signal to the travel mechanism of the vehicle 1.

The determination unit 835 determines whether the state of the driver or the state of the surroundings of the vehicle 1 is a state suitable for transition.

For example, the determination unit 835 determines that the state of the driver is not a state suitable for transition when the driver is not engaging in driving behavior. The determination unit 835 detects a driving behavior of the driver for performing the driving operation from the driver images generated by the driver monitor camera 3 and determines that the state of the driver is not a state suitable for transition when a driving behavior is not detected.

For example, the determination unit 835 detects from the driver images an action such as a surrounding check action of the driver checking the surroundings of the vehicle as driving behavior. The determination unit 835, for example, detects a pupil and a reflected corneal image of the light source by performing template matching between a facial image and respective templates of the pupil and the reflected corneal images of the light source and thereby detects the direction of gaze based on the positional relationship of them. The direction of gaze is represented by the angle of the horizontal direction between the direction of travel of the vehicle 1 and the gaze of the driver. The determination unit 835 detects a driving behavior of the driver when the direction of gaze of the driver is oriented toward the surroundings of the vehicle 1 (for example, 30 degrees or more with respect to the direction of advance).

The determination unit 835 may determine that the state of the driver is not a state suitable for transition when the health condition of the driver is abnormal. The determination unit 835 determines whether the biological information of the driver acquired by a biological information acquisition unit mounted on the vehicle 1 indicates an abnormality in the health condition of the driver and determines that the state of the driver is not a state suitable for transition when the biological information indicates an abnormality in the health condition of the driver.

For example, when the driver monitor camera 3 mounted on the vehicle 1 has sensitivity to visible light, the determination unit 835 can estimate the pulse rate of the driver by detecting from the driver images the change in time of the green color light absorbed by hemoglobin in the blood. The determination unit 835 detects a predetermined skin region of the face of the driver where the skin is exposed in the face (for example, cheek) from the respective driver images by inputting the respective driver images generated as biological information in time series by the driver monitor camera 3 as biological information to a classifier trained in advance to detect the skin region from the images. The classifier can be configured by neural networks such as SegNet and U-Net performing semantic segmentation categorizing each pixel of the images into classes. The determination unit 835 calculates a statistical representative value (for example, average or median) of the green color component of each pixel contained in the detected skin region. The determination unit 835 estimates the pulse rate of the driver corresponding to the period or extent of the change along with time of the representative value of the green color component with reference to a reference table representing the relationship between the period or extent of the change along with time of the green color component and pulse rate. When the estimated pulse rate of the driver deviates from the standard range, the determination unit 835 determines that the biological information of the driver indicates an abnormality in the health condition of the driver and the state of the driver is not suitable for transition.

The determination unit 835 may determine whether the state of the driver is a state suitable for transition by using the color of the face of the driver detected from the driver images generated as biological information by the driver monitor camera 3. The determination unit 835 may detect the skin region of the face of the driver in the driver image by, for example, inputting driver images into a classifier similar to the classifier explained in the above-mentioned estimation of the pulse rate. The determination unit 835 converts the values of each pixel included in the detected skin region from values represented by the RGB color system to values represented by the HLS color system. The determination unit 835 specifies a statistically representative value of the tone of the pixels included in the skin region as a value indicating the color of the face of the driver. If the value indicating the color of the face of the driver deviates from the standard range, the determination unit 835 determines that the biological information of the driver indicates an abnormality of the health condition of the driver and determines that the state of the driver is not a state suitable for transition.

The vehicle 1 may have a pulse sensor as a biological information acquisition unit. The pulse sensor is mounted at the driver's seat and acquires the pulse of the driver as biological information. When the pulse rate of the driver deviates from the standard range, the biological information of the driver indicates an abnormality in the health condition of the driver. In this case, the determination unit 835 determines that the state of the driver is not a state suitable for transition.

Alternatively, the determination unit 835 may determine that the state of the surroundings of the vehicle 1 is not a state suitable for transition when there is an abnormal traffic flow at the surroundings of the vehicle 1. For example, the determination unit 835 may determine whether an abnormal traffic flow has been detected from the surrounding images generated by the surrounding cameras 2 and determine that the state of the surroundings of the vehicle 1 is not a state suitable for transition when an abnormal traffic flow is detected from the surrounding images.

For example, the determination unit 835 detects the distances in the traveling direction among a plurality of surrounding vehicles at the back from the back surrounding images generated by the back surrounding camera 2-2. The determination unit 835 may estimate the distances among the plurality of surrounding vehicles at the back by performing a process similar to that for the above-mentioned estimation of positions of objects by the travel control unit 831. The determination unit 835 estimates the distances in the traveling direction among the plurality of surrounding vehicles by calculating the differences of distances to the plurality of surrounding vehicles. When the distances in the traveling direction among the plurality of surrounding vehicles at the back are smaller than the distance threshold value, the determination unit 835 detects an abnormal traffic flow at the surroundings of the vehicle 1 and determines that the state of the surroundings of the vehicle 1 is not a state suitable for transition.

The stopping control unit 836 ends the transition demand and the autonomous control and performs safe stopping control of the acceleration, deceleration, and steering of the vehicle 1 so as to have vehicle 1 stop at a safe position when the vehicle 1 reaches the predetermined location P1 without a responsive motion being detected.

The stopping control unit 836 acquires from the storage device 7 the map information at the surroundings of the current position of the vehicle 1 identified by the positioning signal received from the GNSS receiver 6. The stopping control unit 836 detects objects located in the surroundings of the vehicle 1 by inputting the surrounding images to the classifier.

The stopping control unit 836 performs safe stopping control by steering toward a safe position such as a road shoulder identified from the map information and decelerating so that the respective distances to the objects positioned in the surroundings keep longer than a certain length.

The stopping control unit 836 ends the transition demand and the autonomous control and performs safe stopping control after the estimated arrival timing when the responsive motion has not been detected, the vehicle 1 has not arrived at the predetermined location P1, and the state of the driver or the state of the surroundings of the vehicle 1 is determined not a state suitable for transition.

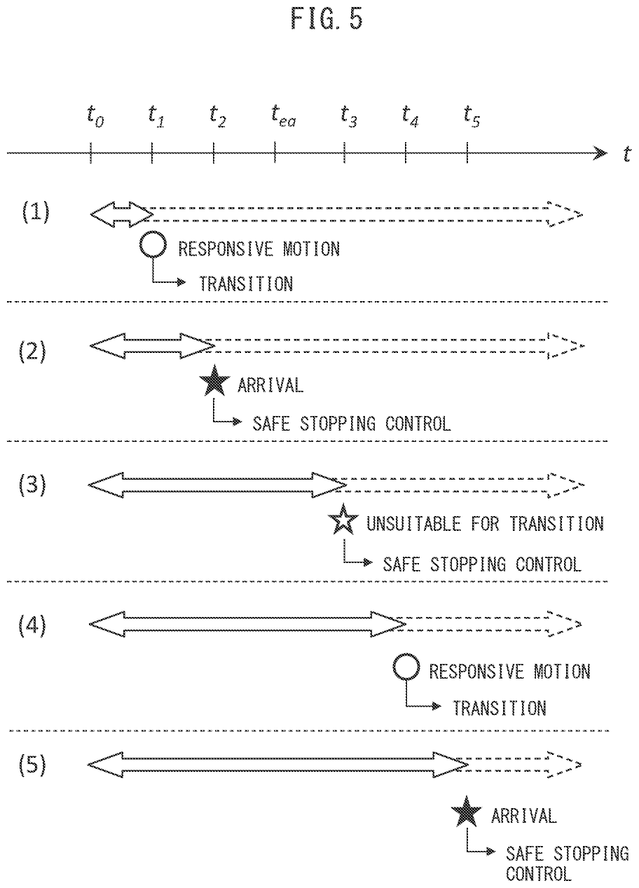

FIG. 5 schematically illustrates an example of travel control. In FIG. 5, part (1) to part (5) respectively represent the detected situation and the corresponding travel control thereto after notification of a transition demand started at a time t₀ a predetermined time period before the time t e a corresponding to the estimated arrival timing.

Part (1) of FIG. 5 represents the situation where a responsive motion to notification of a transition demand started at the time t₀ is detected at a time t₁ before a time t e a corresponding to the estimated arrival timing and before the vehicle 1 arrives at the predetermined location P1. In the situation represented in (1) of FIG. 5, a responsive motion is detected before the vehicle 1 reaches the predetermined location P1. In this case, the transition unit 834 of the ECU 8 ends the transition demand and the autonomous control and starts acceptance of a driving operation (transition).

Part (2) of FIG. 5 represents the situation where the vehicle 1 arrives at the predetermined location P1 at the time t₂ before a responsive motion to notification of a transition demand started at the time t₀ has been detected and before the time t_{e a} corresponding to the estimated arrival timing. In the situation represented in (2) of FIG. 5, the vehicle 1 reaches the predetermined location P1 without a responsive motion being detected. In this case, the stopping control unit 836 of the ECU 8 ends the transition demand and the autonomous control and performs safe stopping control (safe stopping control).

Part (3) of FIG. 5 represents the situation where the state of the driver or the state of the surroundings of the vehicle 1 is determined as not a state suitable for transition at a time t₃ after the time t_{e a} corresponding to the estimated arrival timing, before a responsive motion to notification of a transition demand started at the time t₀ has been detected, and before the vehicle 1 arrives at the predetermined location P1. In the situation represented in (3) of FIG. 5, the time t_{e a} corresponding to the estimated arrival timing is over, no responsive motion is detected, the vehicle 1 has not arrived at the predetermined location P1, and the state of the driver or the state of the surroundings of the vehicle 1 is determined as not a state suitable for transition. In this case, the stopping control unit 836 of the ECU 8 ends the transition demand and the autonomous control and performs safe stopping control (safe stopping control).

Part (4) of FIG. 5 represents the situation where a responsive motion to notification of a transition demand started at the time t₀ has been detected at the time t₄ after a time t e a corresponding to the estimated arrival timing and before the vehicle 1 arrives at the predetermined location P1. In the situation represented in (4) of FIG. 5, the responsive motion is detected before the vehicle 1 arrives at the predetermined location P1. In this case, the transition unit 834 of the ECU 8 ends the transition demand and the autonomous control and starts acceptance of a driving operation (transition).

Part (5) of FIG. 5 represents the situation where the vehicle 1 arrives at the predetermined location P1 at the time t₅ before a responsive motion to notification of a transition demand started at the time t₀ has been detected and after the time t_{e a} corresponding to the estimated arrival timing. In the situation represented in (5) of FIG. 5, the vehicle 1 arrives at the predetermined location P1 without a responsive motion being detected. In this case, the stopping control unit 836 of the ECU 8 ends the transition demand and the autonomous control and performs safe stopping control (safe stopping control).

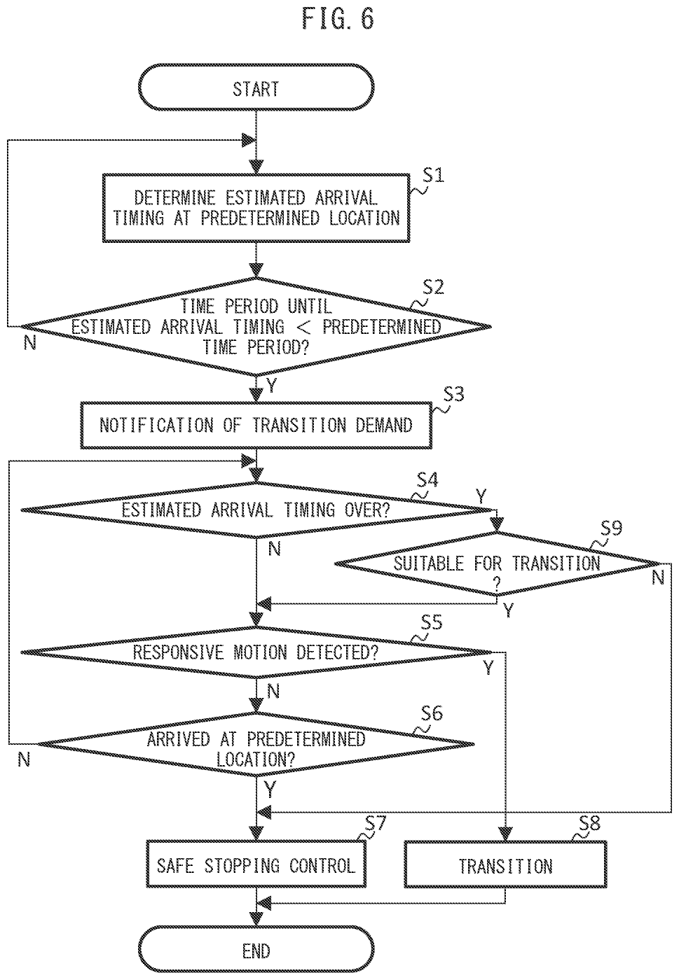

FIG. 6 is a flowchart of a process for travel control. The ECU 8 repeats the processing at predetermined time intervals (e.g., intervals of 1/10 second) during travel of the vehicle 1 under autonomous control.

First, the estimation unit 832 of the ECU 8 estimates an estimated arrival timing at which the vehicle 1 is expected to arrive at a predetermined location where autonomous control by the travel control unit 831 can no longer be continued, based on the current position of the vehicle 1 and the map information stored in the storage device 7 (step S1).

The notification unit 833 of the ECU 8 determines whether the time period from the current time to the estimated arrival timing at the predetermined location P1 determined by the estimation unit 832 is shorter than a predetermined time period stored in the memory 82 (step S2). When the time period from the current time to the estimated arrival timing is determined not shorter than the predetermined time period (step S2: N), the processing of the ECU 8 returns to the above-mentioned step S1.

When the time period from the current time to the estimated arrival timing is determined shorter than the predetermined time period (step S2: Y), the notification unit 833 starts notification of the transition demand to the driver (step S3).

The stopping control unit 836 of the ECU 8 determines whether the current time is after the estimated arrival timing (step S4).

If it the current time is determined not after the estimated arrival timing (step S4: N), the transition unit 834 of the ECU 8 determines whether a responsive motion of the driver corresponding to the transition demand has been detected (step S5).

When a responsive motion has not been detected (step S5: N), the stopping control unit 836 determines whether the vehicle 1 has arrived at the predetermined location (step S6).

When at step S6 the vehicle 1 has reached the predetermined location (step S6: Y), the stopping control unit 836 ends the transition demand and autonomous control, performs safe stopping control (step S7), and terminates the travel control processing.

When the vehicle 1 has not reached the predetermined location (step S6: N), the processing of the ECU 8 returns to the above-mentioned step S4.

When at step S5 a responsive motion has been detected (step S5: Y), the transition unit 834 executes transition, that is, ends the transition demand and the autonomous control and starts acceptance of a driving operation (step S8), and terminates travel control processing.

When at step S4 the current time is determined after the estimated arrival timing (step S4: Y), the determination unit 835 of the ECU 8 determines whether the state of the driver or the state of the surroundings of the vehicle 1 is a state suitable for transition (step S9).

When at step S9 the state of the driver or the state of the surroundings of the vehicle 1 is determined a state suitable for transition (step S9: Y), the processing of ECU 8 proceeds to the above-mentioned step S5.

When at step S9 the state of the driver or the state of the surroundings of the vehicle 1 is determined not a state suitable for transition (step S9: N), the processing of ECU 8 proceeds to the above-mentioned step S7 where the stopping control unit 836 ends the transition demand and the autonomous control and performs safe stopping control.

The ECU 8 can suitably control the operation of a vehicle after the end of travel under autonomous control.

Note that those skilled in the art can apply various changes, substitutions, and modifications without departing from the spirit and scope of the present disclosure.

What is claimed is:

1. A travel controller comprising a processor configured to autonomously control at least one of acceleration, deceleration, and steering of a vehicle by using map information,
estimate an estimated arrival timing at which the vehicle is expected to arrive at a predetermined location where autonomous control can no longer be continued, based on the current location of the vehicle and the map information,
start notification to a driver of a transition demand demanding transition of operation from the autonomous control to a manual control of acceleration, deceleration, and steering of the vehicle based on a driving operation of the driver of the vehicle a predetermined time period before the estimated arrival timing,
end the transition demand and the autonomous control and start acceptance of the driving operation when a responsive motion of the driver to the transition demand is detected before the vehicle arrives at the predetermined location, and
end the transition demand and the autonomous control and perform safe stopping control of acceleration, deceleration, and steering of the vehicle so that the vehicle stops at a safe position when the vehicle arrives at the predetermined location without a responsive motion being detected.

2. The travel controller according to claim 1, wherein the processor is further configured to determine whether a state of the driver or a state of the surroundings of the vehicle is a state suitable for the transition and,
in the safe stopping control, the processor ends the transition demand and the autonomous control and performs safe stopping control after the estimated arrival timing when the responsive motion has not been detected, the vehicle has not arrived at the predetermined location, and the state of the driver or the state of the surroundings of the vehicle is determined as not a state suitable for the transition.

3. The travel controller according to claim 2, wherein the processor in determination of the state of the driver or the state of the surroundings determines that the state of the driver is not a state suitable for transition when driving behavior of the driver for performing the driving operation is not detected from a driver image representing the driver generated by a driver monitor camera mounted on the vehicle.

4. The travel controller according to claim 2, wherein the processor in determination of the state of the driver or the state of the surroundings determines that the state of the driver is not a state suitable for transition when biological information of the driver acquired by a biological information sensor mounted on the vehicle indicates an abnormality in a health condition of the driver.

5. The travel controller according to claim 2, wherein the processor in determination of the state of the driver or the state of the surroundings determines that the state of the surroundings of the vehicle is not a state suitable for transition when an abnormal traffic flow is detected from a surrounding image representing the state of the surroundings of the vehicle acquired by a surrounding camera mounted on the vehicle.

6. A travel control method comprising:
autonomously controlling at least one of acceleration, deceleration, and steering of a vehicle by using map information,
estimating an estimated arrival timing at which the vehicle is expected to arrive at a predetermined location where autonomous control can no longer be continued based on the current location of the vehicle and the map information,
starting notification to a driver of a transition demand demanding a transition of operation from the autonomous control to a manual control of acceleration, deceleration, and steering of the vehicle based on a driving operation of the driver of the vehicle a predetermined time period before the estimated arrival timing,
ending the transition demand and the autonomous control and starting acceptance of the driving operation when a responsive motion of the driver to the transition demand is detected before the vehicle reaches the predetermined location, and
ending the transition demand and the autonomous control and performing safe stopping control of acceleration, deceleration, and steering of the vehicle so that the vehicle stops at a safe position when the vehicle arrives at the predetermined location without a responsive motion being detected.

7. A non-transitory computer-readable medium in which is stored a computer program for travel control for causing a computer mounted in a vehicle to execute a process including:
autonomously controlling at least one of acceleration, deceleration, and steering of a vehicle by using map information,
estimating an estimated arrival timing at which the vehicle is expected to arrive at a predetermined location where autonomous control can no longer be continued based on the current location of the vehicle and the map information,
starting notification to a driver of a transition demand demanding a transition of operation from the autonomous control to a manual control of acceleration, deceleration, and steering of the vehicle based on a driving operation of the driver of the vehicle a predetermined time period before the estimated arrival timing,
ending the transition demand and the autonomous control and starting acceptance of the driving operation when a responsive motion of the driver to the transition demand is detected before the vehicle arrives at the predetermined location, and
ending the transition demand and the autonomous control and performing safe stopping control of acceleration, deceleration, and steering of the vehicle so that the vehicle stops at a safe position when the vehicle arrives at the predetermined location without a responsive motion being detected.
